(19) United States
(12) Patent Application Publication
(10) Pub. No.: US 2026/0315309 A1
(43) Pub. Date: Oct. 15, 2026

(54) Selectively Inflatable Device with Independent Pressurization and Depressurization

(71) Applicant: IPLEXXUS HOLDINGS, LLC, Freeland, MI (US)

(72) Inventor: David A. DZIOBA, Freeland, MI (US)

(21) Appl. No.: 19/464,067

(22) Filed: Jan. 29, 2026

Related U.S. Application Data
(60) Provisional application No. 63/751,373, filed on Jan. 30, 2025.

(51) Int. Cl. A61H 9/00

(52) U.S. Cl. CPC A61H 9/0078; A61H 2201/5056

(57) ABSTRACT

A therapeutic device includes a first flexible sheet joined to a second flexible sheet, thereby defining a selectively inflatable compartment including first and second inflatable chambers and a manifold fluidly connected to the first and second inflatable chambers. The manifold is configured to receive pressurized fluid from a controller and provide the pressurized fluid to the first and second inflatable chambers. The manifold also is configured to receive the pressurized fluid from the first and second inflatable chambers and vent the pressurized fluid to the controller. The selectively inflatable compartment also includes a first variable flow restrictor fluidly connected between the manifold and the first inflatable chamber, a second variable flow restrictor fluidly connected between the manifold and the second inflatable chamber, and an actuator. The actuator is configured to place the first and second variable flow restrictors into respective second states in response to the manifold receiving the pressurized fluid from the controller, and to enable the first and second variable flow restrictors to adopt respective first states in response to venting the pressurized fluid from the controller.

### CROSS-REFERENCE TO RELATED APPLICATIONS

This application claims benefit under 35 U.S.C. §119 of U.S. Provisional Patent Application No. 63/751,373, filed on Jan. 30, 2025, and incorporates by reference the disclosure thereof in its entirety. This disclosure incorporates by reference in their entireties the disclosures of: U.S. Provisional Patent Application No. 63/566,579, filed on Mar. 18, 2024; U.S. Provisional Patent Application No. 63/652,453, filed on May 28, 2024; and U.S. Provisional Patent Application No. 63/811,011, filed on May 23, 2025. To the extent a conflict may exist between the foregoing disclosures and the present disclosure, the present disclosure shall prevail.

### BACKGROUND OF THE DISCLOSURE

Selectively inflatable therapeutic devices, for example, support surface overlays directed to mitigation of decubitus ulcers and sequential compression devices directed to promotion of directional blood flow, are known in the art. Some such therapeutic devices include plural independently and selectively inflatable compartments. Inflation and deflation of the plural inflatable compartments typically is effected by a controller coupled to the therapeutic device. Such controllers typically include a pneumatic pump and an arrangement of valves configured to independently and selectively direct pressurized air to one or more or all of the plural inflatable compartments, and to independently and selectively vent air from one or more or all of the plural inflatable compartments.

For example, a typical support surface overlay includes at least first and second selectively and alternatingly inflatable compartments defining respective contact areas configured to selectively and alternatingly apply and relieve contact pressure to corresponding portions of a user's body. A typical support surface overlay having first and second selectively and alternatingly inflatable compartments typically is used in conjunction with a controller having a first fluid line fluidly coupled to the first inflatable compartment and a second fluid line fluidly coupled to the second inflatable compartment. A typical controller for a support surface overlay is configured to selectively provide pressurized air to the first inflatable compartment while venting the second inflatable compartment, and to subsequently provide pressurized air to the second inflatable compartment while venting the first inflatable compartment. Each of the first and second inflatable compartments may apply contact pressure to the skin of a user lying thereon when the respective inflatable compartment is inflated, and each of the first and second inflatable compartments may relieve contact pressure from the skin of a user lying thereon when the respective inflatable compartment is deflated. In embodiments, either or both of the first and second inflatable compartments may include plural inflatable chambers. Typically, the plurality of inflatable chambers within a given inflatable compartment are connected together by a common manifold. As such, the plurality of inflatable chambers within a given inflatable compartment typically inflate and deflate in unison with each other, along with inflation and deflation of the inflatable compartment as a whole. Such inflatable chambers typically are arranged in rows and/or columns within the respective inflatable compartment.

A sequential compression device (SCD) is a wearable therapeutic device that includes at least a first selectively inflatable compartment and includes at least first and second selectively inflatable compartments. A typical SCD may include more than first and second selectively inflatable compartments. The selectively inflatable compartment(s) may be inflated and deflated in a manner that promotes directional blood flow, for example, from a user's extremity toward the user's heart. For example, an SCD may take the form of a sock or a cuff that a user may wear on his or her foot or lower leg. Such an SCD may include a first inflatable compartment distant from the user's heart and a second inflatable compartment proximate the user's heart. A typical SCD having at least two selectively and alternatingly inflatable compartments typically is used in conjunction with a controller having a first fluid line fluidly coupled to the first inflatable compartment, a second fluid line fluidly coupled to the second inflatable compartment, and further fluid lines fluidly coupled to respective further inflatable compartments. A typical controller for an SCD is configured to inflate the first inflatable compartment, and then to inflate the second inflatable compartment while maintaining the first inflatable compartment in the inflated state. The controller may subsequently vent and thereby deflate the second inflatable compartment and then vent and thereby deflate the first inflatable compartment while maintaining the second inflatable compartment in the deflated state. Alternatively, the controller may subsequently vent and thereby deflate the first inflatable compartment and then vent and thereby deflate the second inflatable compartment while maintaining the first inflatable compartment in the deflated state.

It would be beneficial to provide a selectively inflatable therapeutic device having at least one selectively inflatable compartment including plural inflatable chambers configured to enable simultaneous or sequential inflation and simultaneous or sequential deflation of the plural inflatable chambers thereof via a single fluid line configured to provide fluid to and relieve fluid from the selectively inflatable compartment.

### SUMMARY OF THE DISCLOSURE

The present disclosure is directed to therapeutic surface including a first flexible sheet and a second flexible sheet overlying and joined to the first flexible sheet to thereby define a first selectively inflatable compartment. The first selectively inflatable compartment includes a manifold configured for fluid coupling to a controller configured to selectively supply pressurized fluid to and vent the pressurized fluid from the first manifold. The first selectively inflatable compartment also includes a first inflatable chamber, a first branch line fluidly coupling the first inflatable chamber to the manifold, a second inflatable chamber, and a second branch line fluidly coupling the second inflatable chamber to the first manifold. The first branch line includes a first variable flow restrictor operable between a first state wherein the first variable flow restrictor has a first, relatively low resistance to flow at a reference differential pressure across the first variable flow restrictor orifice, and a second state wherein the first variable flow restrictor has a first relatively high resistance to flow at the reference differential pressure across the first variable flow restrictor. The second branch line includes a second variable flow restrictor operable between a first state wherein the second variable flow restrictor orifice has a second relatively low resistance to flow at the reference differential pressure across the second variable flow restrictor, and a second state wherein the second variable flow restrictor orifice has a second relatively high resistance to flow at the reference differential pressure across the second flow restrictor orifice. The first selectively inflatable compartment further includes an actuator operable to transition the first variable flow restrictor between its first and second states and to transition the second variable flow restrictor between its first and second states.

In embodiments, the first variable flow restrictor is a first variable orifice, and the second variable flow restrictor is a second variable orifice.

In embodiments, the actuator includes a first actuator element integral with the manifold on a first side of the first branch line and a second actuator element integral with the manifold on a second side of the first branch line opposite the first side of the first branch line. The first actuator element and the second actuator element cooperate to apply a tensile force to the first sheet and the second sheet between the first actuator element and the second actuator element in response to provision of the pressurized fluid from the controller to the manifold. Application of the tensile force causes the first variable orifice to adopt the second state and wherein absence of the tensile force enables the first variable orifice to adopt the first state.

### BRIEF DESCRIPTION OF THE DRAWINGS

FIG. 1 depicts an illustrative therapeutic device in the form of a sequential compression device (SCD) having a selectively inflatable compartment including plural inflatable chambers and corresponding flow control systems configured to enable inflation of the plural inflatable chambers simultaneously or sequentially and to enable deflation of the plural inflatable chambers simultaneously or sequentially according to the present disclosure;

FIG. 2 depicts schematically an illustrative therapeutic device in the form of a support surface overlay (SSO) having a selectively inflatable compartment including plural inflatable chambers and corresponding flow control systems configured to enable inflation of the plural inflatable chambers in a simultaneously or sequentially and to enable deflation of the plural inflatable chambers simultaneously or sequentially according to the present disclosure;

FIG. 3 is a top plan view of the therapeutic device of either FIG. 1 or FIG. 2, including the plural inflatable chambers thereof, and a first embodiment of a flow control system configured to enable inflation of the plural inflatable chambers substantially simultaneously or sequentially and to enable deflation of the plural inflatable chambers substantially simultaneously or sequentially, wherein the flow control system is in a first state;

FIG. 4 is a side cross-sectional view of a variable orifice of the flow control system of the therapeutic device of FIG. 3, wherein the variable orifice is in a first state;

FIG. 5 is a top plan view of the therapeutic device of FIG. 3, wherein the flow control system is in a second state;

FIG. 6 is a side cross-sectional view of the variable orifice of the flow control system of the therapeutic device of FIGS. 3 and 5, wherein the variable orifice is in the second state;

FIG. 7 is a top plan view of a variation of the therapeutic device of FIG. 3 including additional inflatable chambers, wherein the flow control system is in the first state;

FIG. 8 is a top plan view of a variation of the therapeutic device of the therapeutic device of FIG. 7, wherein the flow control system is in the second state;

FIG. 9 is a top plan view of another variation of the therapeutic device of FIG. 3 wherein the flow control system is in the first state;

FIG. 10 is a top plan view of a variation of the therapeutic device of the therapeutic device FIG. 7, wherein the flow control system is in the second state;

FIGS. 11 and 12 are top plan views of further variations of the therapeutic device of FIG. 3;

FIGS. 13A-13B are top plan views of the therapeutic device of either FIG. 1 or FIG. 2, including the plural inflatable chambers thereof, and a second embodiment of a flow control system configured to enable inflation of the plural inflatable chambers substantially simultaneously or sequentially and to enable deflation of the plural inflatable chambers substantially simultaneously or sequentially, wherein the flow control system is in a first state;

FIG. 13C is a cross-sectional side elevation view of the therapeutic device of FIGS. 13A-13B, wherein the flow control system is in the first state; and

FIG. 13D is a cross-sectional side elevation view of the therapeutic device of FIGS. 13A-13B, wherein the flow control system is in the second state.

### DETAILED DESCRIPTION OF THE DRAWINGS

The drawings depict various embodiments of therapeutic devices, each such therapeutic device having at least one selectively inflatable compartment, and each such selectively inflatable compartment including plural inflatable chambers. The therapeutic devices are configured so that the plural inflatable chambers may be inflated simultaneously or sequentially in a predetermined inflation sequence, and so that the plural inflatable chambers may be deflated simultaneously or sequentially in a predetermined deflation sequence. In embodiments wherein the plural inflatable chambers may be inflated sequentially and deflated sequentially, the inflation sequence may be the same as or different from the deflation sequence.

The drawings depict embodiments of an illustrative therapeutic device 100 comprising a first flexible sheet 102 and a second flexible sheet 104 overlying and joined to the first flexible sheet 102 by a weld 106. The first and second flexible sheet 102, 104 may be, but need not be, flat. The first flexible sheet 102, the second flexible sheet 104, and the weld 106 cooperate to define a first selectively inflatable compartment 108. The first selectively inflatable compartment may be substantially fluid-tight. The first selectively inflatable compartment 108 is configured to be fluidly coupled to a controller C. The controller C is configured to selectively provide pressurized fluid to, and relieve pressurized fluid from, the first selectively inflatable compartment 108. The pressurized fluid may be a gas, for example, air. In embodiments, the pressurized fluid may be a liquid, for example, water. In embodiments, the therapeutic device 100 may include further selectively inflatable compartments defined by the first flexible sheet 102, the second flexible sheet 104, and the weld 106.

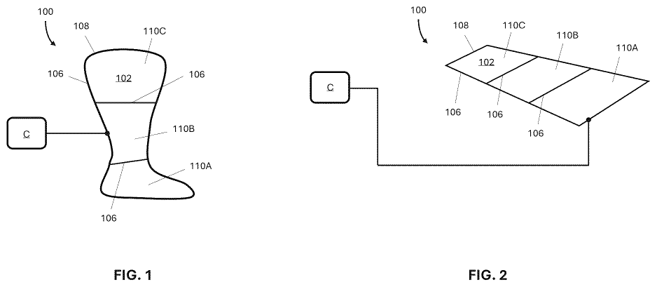

As shown in FIG. 1, the therapeutic device 100 may be embodied as a sequential compression device (SCD). As shown in FIG. 2, the therapeutic device 100 may be embodied as a support surface overlay (SSO). The therapeutic device 100 may be embodied in other forms, as well. In embodiments, the therapeutic device 100 may include plural selectively inflatable compartments, as will be discussed further below.

The first selectively inflatable compartment 108 includes a plurality of fluidly interconnected inflatable chambers 110n. As shown in FIGS. 1 and 2, the first selectively inflatable compartment 108 includes a first inflatable chamber 110A, a second inflatable chamber 110B, and a third inflatable chamber 110C. In embodiments, the first selectively inflatable compartment 108 may include fewer or more than three inflatable chambers 110n. In embodiments, the first selectively inflatable compartment 108 includes at least two inflatable chambers 110n. In embodiments, the first selectively inflatable compartment 108 may include a single inflatable chamber 110. In embodiments including plural selectively inflatable compartments, each selectively inflatable compartment may include two or more inflatable chambers, as will be discussed further below.

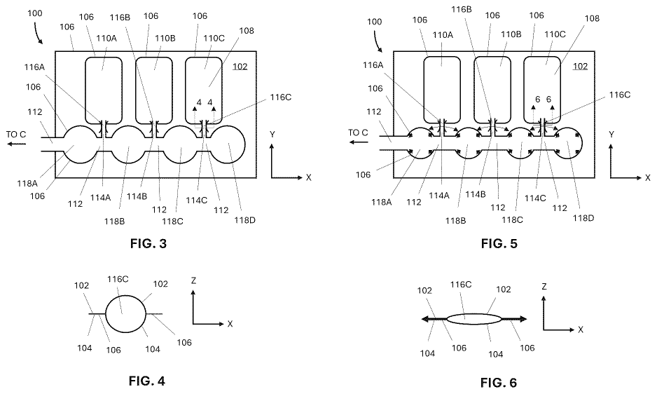

As shown in FIGS. 3-12, ones of the plurality of inflatable chambers 110n may be fluidly connected together by a manifold 112. The manifold 112 may be fluidly coupled to the controller C so that the controller C may selectively provide pressurized fluid to, and vent the pressurized fluid from, the manifold 112 and thereby selectively provide pressurized fluid to and vent the pressurized fluid from the first, second and third inflatable chambers 110A, 110B, 110C.

Branch lines 114n fluidly connect respective ones of the inflatable chambers 110n to the manifold 112. For example, as shown, a first branch line 114A fluidly connects the first inflatable chamber 110A to the manifold 112, a second branch line 114B fluidly connects the second inflatable chamber 110B to the manifold 112, and a third branch line 114C fluidly connects the third inflatable chamber 110C to the manifold 112.

At least one of the branch lines 114n includes a corresponding variable flow restrictor, for example, a variable orifice 116n fluidly connected between the manifold 112 and the corresponding one of the inflatable chambers 110n. Each variable orifice 116n may be configured as a flexible portion of the respective branch line 114n fluidly connecting the corresponding inflatable chamber 110n with the manifold 112. For example, as shown, a first variable orifice 116A is configured as a flexible portion of the branch line 114A fluidly coupling the first inflatable chamber 110A and the manifold 112. Similarly, a second variable orifice 116B is configured as a flexible portion of the branch line 114B fluidly coupling the second inflatable chamber 110B and the manifold 112, and a third variable orifice 116C is configured as a flexible portion of the branch line 114C fluidly coupling the third inflatable chamber 110C and the manifold 112.

As will be discussed further below, each of the variable orifices 116n is operable between a first state wherein the respective variable orifice 116n has a corresponding first cross-sectional area and thereby imparts a corresponding first resistance to flow therethrough at a reference differential pressure, and a second state wherein the respective variable orifice 116n has a corresponding second cross-sectional area and thereby imparts a corresponding second resistance to flow therethrough at the reference differential pressure. Each of the second cross-sectional areas is less than the corresponding first cross-sectional area. As such, each of the second resistances to flow is greater than the corresponding first resistance to flow.

In embodiments, the second resistance to flow through any or all of the respective variable orifices 116n may be only slightly greater than the corresponding first resistances to flow through the respective variable orifices 116n. In embodiments, the second resistance to flow through any or all of the respective variable orifices 116n may be much greater than the corresponding first resistances to flow through the respective variable orifices 116n. For example without limitation, the second resistance to flow through any or all of the respective variable orifices 116n may be at least twice, or three times, or four times, or five times, or six times, or seven times, or eight times, or nine times, or ten times the corresponding first resistances to flow through the respective variable orifices 116n.

Also, the first resistance to flow through any one of the variable orifices 116n may be greater than, less than, or equal to the first resistance to flow of any other one or ones of the variable orifices 116n. Similarly, the second resistance to flow through any one of the variable orifices 116n may be greater than, less than, or equal to the second resistance to flow of any other one or ones of the variable orifices 116n.

For example, the first resistance to flow through the first variable orifice 116A may be greater than, less than, or equal to the first resistance to flow of either or both of the second variable orifice 116B and the third variable orifice 116C. For example, the second resistance to flow through the first variable orifice 116A may be greater than, less than, or equal to the second resistance to flow of either or both of the second variable orifice 116B and the third variable orifice 116C.

Likewise, the first resistance to flow through the second variable orifice 116B may be greater than, less than, or equal to the first resistance to flow of either or both of the first variable orifice 116A and the third variable orifice 116C. Similarly, the second resistance to flow through the second variable orifice 116B may be greater than, less than, or equal to the second resistance to flow of either or both of the first variable orifice 116A and the third variable orifice 116C.

Further, the first resistance to flow through the third variable orifice 116C may be greater than, less than, or equal to the first resistance to flow of either or both of the first variable orifice 116A and the second variable orifice 116B. Similarly, the second resistance to flow through the third variable orifice 116C may be greater than, less than, or equal to the second resistance to flow of either or both of the first variable orifice 116A and the second variable orifice 116B.

In embodiments, differences in first resistances to flow among the variable orifices 116n may be negligible compared to differences in second resistances to flow among the variable orifices 116n so as to enable substantially sequential inflation and pressurization of the inflatable chambers 110n, while also enabling substantially simultaneous deflation and depressurization of the inflatable chambers, as will be discussed further below. In embodiments, such differences between the first resistances to flow and the second resistances to flow among the variable orifices 116n may enable substantially simultaneous inflation and pressurization of the inflatable chambers 110n, while also enabling substantially sequential deflation and depressurization of the inflatable chambers, as will be discussed further below.

In any event, the resistance to flow through the manifold 112 between the controller C and the branch lines 114n may be substantially less than the resistance to flow through any of the variable orifices 116n, regardless of whether the variable orifices 116n are in their respective first or second states.

Nonlimiting examples of possible combinations of first and second resistances to flow through the variable orifices 116n will be discussed further below.

An actuator 118 is operably associated with the variable orifices 116n. The actuator 118 cooperates with the variable orifices 116n to define a flow control system. The actuator 118 is configured to selectively and substantially simultaneously transition the variable orifices 116n between their respective first states and second states by selectively applying and releasing force to the flexible portion of the corresponding branch line 114n comprising the respective variable office 116n. Such force may be a tensile force or a compressive force, as will be discussed further below. In the absence of such a force to the flexible portion of the corresponding branch line 114n comprising the respective variable office 116n, the respective variable orifice 116n may assume its first state wherein the cross-sectional area of the respective variable orifice 116nis large compared to its cross-sectional area in its second state, and wherein its resistance to fluid flow is low compared to its resistance to flow in its second state. Conversely, application of such a force to the flexible portion of the corresponding branch line 114n comprising the respective variable office 116n places the respective variable orifice 116n in its second state wherein the cross-sectional area of the respective variable orifice 116n is small compared to its cross-sectional area in its first state, and wherein its resistance to fluid flow is high compared to its resistance to flow in its first state.

In a first embodiment, as shown for example in FIGS. 3-6, the actuator 118 is embodied as a plurality of actuator elements 118A, 118B, 118C, 118D incorporated into the manifold 112. As such, each of the actuator elements 118A, 118B, 118C, 118D is defined by the first flexible sheet 102, the second flexible sheet 104 and the weld 106. As shown, each of the actuator elements 118n may be an enlarged portion of the manifold 112. As shown, each of the actuator elements is shown as generally circular (and thus inflatable to a generally spherical shape). In embodiments, the actuator elements 118n may take other shapes and forms, for example without limitation, generally square, oblong, arcuate, or U-shaped.

Corresponding pairs of the actuator elements 118A, 118B, 118C, 118D are disposed about respective ones of the respective portions of the flexible portion of the corresponding branch lines 114n comprising the respective ones of the variable orifices 116n, for example without limitation, on opposite sides of the respective ones of the variable orifices 116n. For example, as shown, the first and second actuator elements 118A, 118B are disposed about the first variable orifice 116A on opposite sides of the first variable orifice 116A. Similarly, the second and third actuator elements 112B, 112C are disposed about the second variable orifice 110B on opposite sides of the second variable orifice 110B. Likewise, the third and fourth actuator elements 112C, 112D are disposed about the third variable orifice 110C on opposite sides of the third variable orifice 110C.

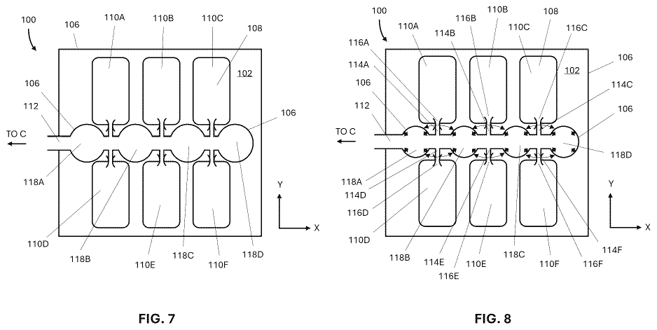

So configured, the corresponding pairs of actuator elements 118n are operable to transition the respective flexible portions of the corresponding branch lines 114n comprising the respective ones of the variable orifices 116n between the first and second states referred to above in response to inflation and deflation of the first selectively inflatable compartment 108. FIG. 3 shows the first selectively inflatable compartment 108 in a deflated state. FIGS. 5-6 show the first selectively inflatable compartment 108 in an inflated state and the variable orifices 116n in their respective second states. FIG. 4 shows the first variable orifice 116A in its first state as it and the other variable orifices 116n might exist while the first selectively inflatable compartment 108 is deflating from the inflated state to the deflated state.

With reference to FIG. 3, when the first selectively inflatable compartment 108 is in the deflated state, the first and second sheets 102, 104 comprising the first selectively inflatable compartment 108, including the inflatable chambers 110n, the manifold 112, the branch lines 114n, and the actuator elements 118n, may lie substantially against each other, and may thereby substantially conform to the contour of an underlying surface. For example without limitation, when the first selectively inflatable compartment 108 is in the deflated state, the first and second sheets 102, 104 may lie substantially flat upon a substantially flat surface.

With reference to FIGS. 5-6, while the first selectively inflatable compartment 108 is being inflated with pressurized fluid or when it is in the inflated state and thus is filled with pressurized fluid, fluid pressure in the first selectively inflatable compartment 108 causes the first and second sheets 102, 104 of the first selectively inflatable compartment 108 in regions defining the inflatable chambers 110n, the manifold 112, the branch lines 114n comprising the variable orifices 116n, and the actuator elements 118n to be displaced from each other in the z-direction. Consequently, the periphery of each of the actuator elements 118n tends to be drawn inwardly in the x-y plane compared to its position in the deflated state, as represented by the arrows within the actuator elements 118n pointing inwardly from the periphery of each of the actuator elements 118n toward respective centroids thereof.

The foregoing phenomena establish corresponding tensile forces in the first and sheets 102, 104 in the x-y plane between adjacent ones of the actuator elements 118n. (The foregoing displacement of the first and second flexible sheets 102, 104 apart from each other in the z-direction also establishes corresponding tensile forces in the first and sheets 102, 104 in the x-y plane between adjacent ones of the inflatable chambers 110n and may further establish corresponding tensile forces in the first and sheets 102, 104 in the x-y plane between other portions of the first selectively inflatable compartment 108 receiving pressurized fluid.) These tensile forces act on corresponding sidewalls of the respective branch lines 114n comprising the variable orifices 116n predominantly in the x-direction. As such, these tensile force tends to elongate respective portions of the cross-sections of the respective ones of the branch lines 114n, as shown for example without limitation in FIG. 6, thereby decreasing the cross-sectional areas thereof and increasing the resistance to fluid flow therethrough. These tensile forces overcome internal fluid pressure forces tending to enlarge the cross-sectional areas of the respective ones of the branch lines 114n comprising the variable orifices 116n.

For example, the foregoing phenomena establish a corresponding tensile force in the first and sheets 102, 104 in the x-y plane between the first actuator element 118A and the second actuator element 118B. This tensile force is represented schematically in FIG. 5 as the arrow pointing to the first actuator element 118A and the second actuator element 118B, and passing through the first variable orifice 116A. This tensile force acts on corresponding sidewalls of the first branch line 114A comprising the first variable orifice 116A predominantly in the x-direction. As such, this tensile force tends to elongate the cross-section of the portion of the first branch line 114A comprising the first variable orifice 116A, as shown for example without limitation in FIG. 6, thereby imparting a relatively high resistance to fluid flow therethrough.

Similarly, the foregoing phenomena establish a corresponding tensile force in the first and sheets 102, 104 in the x-y plane between the second actuator element 118B and the third actuator element 118C. This tensile force is represented schematically in FIG. 5 as the arrow pointing to the second actuator element 118B and the third actuator element 118C, and passing through the second variable orifice 116B. This tensile force acts on corresponding sidewalls of the second branch line 114B comprising the second variable orifice 116B predominantly in the x-direction. As such, this tensile force tends to elongate the cross-section of the portions of the second branch line 114B comprising the second variable orifice 116B, for example without limitation, in a manner similar to that shown in FIG. 6, thereby imparting a relatively high resistance to fluid flow therethrough.

Likewise, the foregoing phenomena establish a corresponding tensile force in the first and sheets 102, 104 in the x-y plane between the third actuator element 118C and the fourth actuator element 118D. This tensile force is represented schematically in FIG. 5 as the arrow pointing to the third actuator element 118C and the fourth actuator element 118D, and passing through the third variable orifice 116C. This tensile force acts on corresponding sidewalls of the third branch line 114C comprising the third variable orifice 116C predominantly in the x-direction. As such, this tensile force tends to elongate the cross-section of the portions of the third branch line 114C comprising the third variable orifice 116C, for example without limitation in a manner similar to that shown in FIG. 6, thereby imparting a relatively high resistance to fluid flow therethrough.

When the pressurized fluid is vented from the first selectively inflatable compartment 108, the fluid pressure in the manifold 112 and the actuator elements 118n decreases quickly compared to the fluid pressure in the inflatable chambers 110n because the resistance to flow through the manifold 112 is substantially less than the resistance to flow through any of the variable orifices 116n in their respective second states. Consequently, the tensile forces between corresponding ones of the actuator elements 118n lessen quickly compared to lessening of fluid pressure within the inflatable chambers 110n. Thus, the fluid pressure in the inflatable chambers 110n and the branch lines 114n comprising the variable orifices 116n overcomes the corresponding tensile forces imparted by the actuator elements 118n, in turn causing the variable orifices 116n to transition to their first states, for example without limitation as shown in FIG. 4, wherein the variable orifices 116n have relatively large cross-sectional areas and thus impart relatively little resistance to flow. As such, the inflatable chambers 110n may be deflated or depressurized more quickly than they may be inflated or pressurized.

In use, the variable orifices 116n are initially in their respective first states. Pressurized fluid, for example without limitation, air, then is selectively provided to the manifold 112, for example without limitation, by the controller C. The resistance to flow through the manifold 112 is substantially less than the resistance to flow through any of the variable orifices 116n, regardless of whether the variable orifices 116n are in the respective first or second states. As such, the introduction of the pressurized fluid pressure to the manifold 112 causes the fluid pressure in the manifold 112 and the actuator elements 118n therein to increase substantially faster than the fluid pressure in the inflatable chambers 110n. Thus, the introduction of the pressurized fluid to the manifold 112 substantially initially causes each of the actuator elements 118n to expand in the z-direction and contract in the x-y plane, thereby establishing tensile forces in the first and seconds sheets 102, 104 that act on the variable orifices 116n to place them in their respective second states, as discussed further above. Continued provision of the pressurized fluid to the manifold 112 then causes the ones of the inflatable chambers 110n to inflate and become pressurized substantially simultaneously or sequentially as a function of the relative resistances to flow of the variable orifices 116n in their second states.

For example without limitation, the resistance to flow through the first variable orifice 116A in its second state may be substantially greater than the resistance to flow through the second variable orifice 116B in its second state, which may in turn be substantially greater than the resistance to flow through the third variable orifice 116C in its second state. With the variable orifices 116n so configured, the third inflatable chamber 110C would inflate and become pressurized before the second inflatable chamber 110B, which in turn would inflate and become pressurized before the first inflatable chamber 110A. As another non-limiting example, each of the first, second, and third variable orifices 116A, 116B, 116C could have substantially the same resistance to flow in the second state. With the variable orifices 116n so configured, the first, second, and third inflatable chambers 110A, 110B, 110C would inflate and become pressurized substantially simultaneously.

The pressurized fluid may subsequently be vented from the manifold 112, for example without limitation, to the controller C. Because the resistance to flow through the manifold 112 is substantially less than the resistance to flow through any of the variable orifices 116n, regardless of whether the variable orifices 116n are in the respective first or second states, the venting of the pressurized fluid pressure from the manifold 112 causes the fluid pressure in the manifold 112 and the actuator elements 118n therein to decrease substantially faster than the fluid pressure in the inflatable chambers 110n. As such, the venting of the pressurized fluid to the manifold 112 substantially initially permits the selectively expandable elements 118n to contract in the z-direction, release at least a substantial portion of the tensile force in the x-y plane, and thereby allow the corresponding variable orifices 116n to adopt their respective first state. Continued venting of the pressurized fluid from the manifold 112 then causes the ones of the inflatable chambers 110n to deflate and become depressurized substantially simultaneously or sequentially as a function of the relative resistances to flow of the variable orifices 116n in their first states.

For example without limitation, the resistance to flow through the first variable orifice 116A in its first state may be substantially greater than the resistance to flow through the second variable orifice 116B in its first state, which may in turn be substantially greater than the resistance to flow through the third variable orifice 116C in its first state. With the variable orifices 116n so configured, the third inflatable chamber 110C would deflate and become depressurized before the second inflatable chamber 110B, which in turn would deflate and become depressurized before the first inflatable chamber 110A. As another non-limiting example, each of the first, second, and third variable orifices 116A, 116B, 116C could have substantially the same resistance to flow in the first state. With the variable orifices 116n so configured, the first, second, and third inflatable chambers 110A, 110B, 110C would deflate and become depressurized substantially simultaneously.

In embodiments, the actuator 118 and the variable orifices 116n could be configured so that the resistances to flow through respective ones of the variable orifices 116n in the second state are substantially different from each other, but the corresponding resistances to flow in the first state are substantially the same. With the variable orifices 116n so configured, the inflatable chambers 110n could be inflated and pressurized substantially sequentially, and subsequently deflated and depressurized substantially simultaneously. For example without limitation, the resistance to flow through the first variable orifice 116A in its second state may be substantially greater than the resistance to flow through the second variable orifice 116B in its second state, which may in turn be substantially greater than the resistance to flow through the third variable orifice 116C in its second state. Each of these resistances to flow in the second state could be sufficiently greater than the corresponding resistances to flow in the first state such that the resistances to flow through the first, second, and third variable orifices 116A, 116B, 116C in the first state are substantially similar. With the variable orifices 116n so configured, the third inflatable chamber 110C would inflate and become pressurized before the second inflatable chamber 110B, which in turn would inflate and become pressurized before the first inflatable chamber 110A. Also with the variable orifices 116n so configured, the first, second, and third inflatable chambers 110A, 110B, 110C would deflate and become depressurized substantially simultaneously.

In any event, the resistance to flow through each of the variable orifices 116n of the FIGS. 3-6 embodiment in the second state may substantially greater than the corresponding resistances to flow therethrough in the first state so that the inflatable chambers 110n may be deflated substantially more rapidly than they may be inflated.

FIGS. 7 and 8 show a variation of the embodiment of FIGS. 3-6, further including a fourth inflatable compartment 110D on the opposite side of the manifold 112 from the first inflatable compartment 110A, a fifth inflatable compartment 110E on the opposite side of the manifold 112 from the second inflatable compartment 110B, and a sixth inflatable compartment 110F on the opposite side of the manifold 112 from the third inflatable compartment 110C. The fourth inflatable compartment 110D is fluidly coupled to the manifold 112 by a fourth branch line 114D, the fifth inflatable compartment 110E is fluidly coupled to the manifold 112 by a fifth branch line 114E, and the sixth inflatable compartment 110F is fluidly coupled to the manifold 112 by a sixth branch line 114F. The fourth, fifth, and sixth branch lines 114D, 114E, 114E are similar to the first, second, and third branch lines 114A, 114B, 114C. A fourth variable orifice 116D is fluidly connected between the fourth inflatable chamber 110D and the manifold 112, a fifth variable orifice 116E is fluidly connected between the fifth inflatable chamber 110E and the manifold 112, and a sixth variable orifice 116F is fluidly connected between the sixth inflatable chamber 110F and the manifold 112. The fourth, fifth, and sixth variable orifices 116D, 116E, 116F may be configured in manner similar to the first, second, and third variable orifices 116A, 116B, 116C, though any or all of the fourth, fifth, and sixth variable orifices 116D, 116E, 116F may impart different resistances to flow therethrough than any or all of the first, second, and third variable orifices 116A, 116B, 116C, in the respective first states, the respective second states, or both.

In use, the actuator 118 is operable to transition the fourth, fifth, and sixth variable orifices 116D, 116E, 116F between their respective first and second states in the same manner that the actuator 118 is operable to transition the first, second, and third variable orifices 110A, 110B, 110C, respectively, between their respective first and second states. The actuator 118 and the variable orifices 116n may be selected to enable substantially simultaneous or sequential inflation and deflation of the corresponding inflatable compartments 110n in manners similar to those described above in connection with FIGS. 3-6.

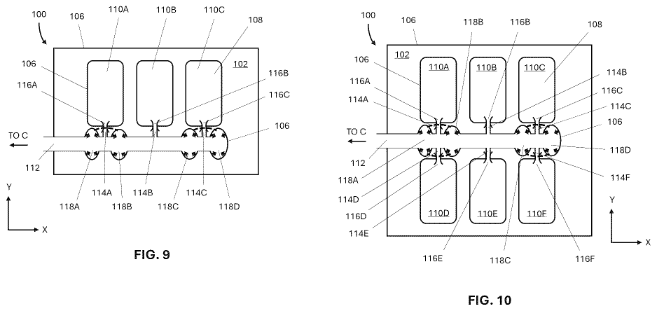

FIG. 9 shows another variation of the embodiment of FIGS. 3-6, with the first selectively inflatable compartment 102 in the inflated or pressurized state. In the FIG. 9 embodiment, the first and second actuator elements 118A, 118B are located sufficiently proximate the first variable orifice 116A to enable the first and second actuator elements 118A, 118B to selectively apply and release a tensile force to and from the first and second sheets 102, 104 of the therapeutic device 100 acting on the first variable orifice 116A and to thereby transition the first variable orifice 116A between its first and second states, further to the principles and phenomena discussed above. Similarly, the third and fourth actuator elements 118C, 118D are located sufficiently proximate the third variable orifice 116C to enable the third and fourth actuator elements 118C, 118D to selectively apply and release a tensile force to and from the first and second sheets 102, 104 of the therapeutic device 100 acting on the third variable orifice 116C and to thereby transition the third variable orifice 116C between its first and second states, further to the principles and phenomena discussed above. The second and third actuator elements 118B, 118C, however, are located sufficiently distant from the second variable orifice 116B to not enable the second and third actuator elements 118B, 118C to selectively apply and release a tensile force to and from the first and second sheets 102, 104 of the therapeutic device 100 acting on the second variable orifice 116B sufficient to thereby substantially transition the second variable orifice 116B between its first and second states, further to the principles and phenomena discussed above. As such, the second variable orifice 116B essentially functions as a fixed orifice in this embodiment.

In the FIG. 9 embodiment, corresponding pairs of the actuator elements 118n are configured sufficiently proximate the first and third variable orifices 116A, 116C to enable the corresponding pairs of the actuator elements 118n to transition the first and third variable orifices 116A, 116C between their respective first and second states, further to the principles discussed above, but are configured sufficiently distant from the second variable orifice 116B so as to be unable to transition the second variable orifice 116B between their respective first and second state. In other embodiments, at least one corresponding pair of the actuator elements 118n may be configured sufficiently proximate any respective one of the variable orifices 116n to enable the pair of the actuator elements 118n to transition the respective one of the variable orifices 116n between its first and second states. Further corresponding pairs of the actuator elements 118n may be configured sufficiently proximate to or sufficiently distant from any other respective one or ones of the variable orifices 116n so as to enable or not enable the further corresponding pairs of the actuator elements 118n to transition the respective one or ones of the variable orifices 116n between their respective first and second states.

FIG. 10 shows a variation of the FIG. 9 embodiment, further including a fourth inflatable chamber 110D fluidly connected to the manifold 112 by a fourth branch line 114D including a fourth variable orifice 116D, a fifth inflatable chamber 110E fluidly connected to the manifold 112 by a fifth branch line 114E including a fifth variable orifice 116E, and a sixth inflatable chamber 110F fluidly connected to the manifold 112 by a sixth branch line 114F including a fourth variable orifice 116F. The operation of the FIG. 10 embodiment should be readily understood in view of the descriptions of operation of the FIGS. 3-9 embodiments and thus will not be discussed further.

The actuator 118 and the variable orifices 116n of the FIGS. 9 and 10 embodiments may be selected to enable substantially simultaneous or sequential inflation and deflation of the corresponding inflatable compartments 110n in manners similar to those described above in connection with FIGS. 3-6.

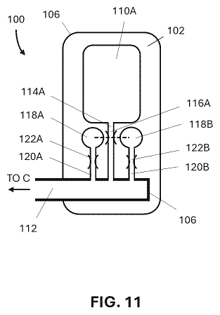

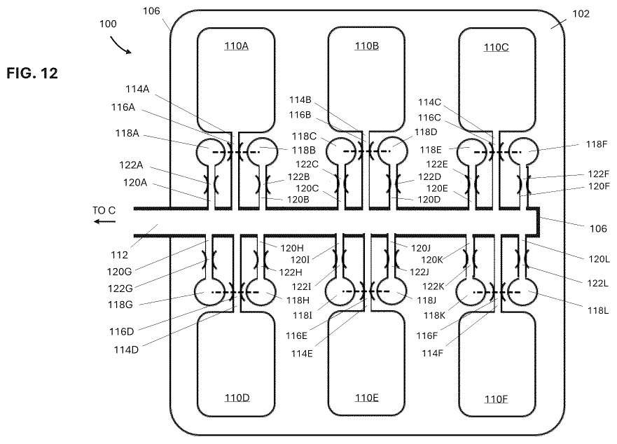

FIGS. 11-12 show embodiments wherein the actuator elements 118n are not incorporated into the manifold 112 but are instead fluidly coupled to the manifold 112 via corresponding actuator element branch lines 120n. Each of the actuator element branch lines 120n may comprise a corresponding resistance to flow symbolized by a corresponding actuator branch line orifice 122n. In this embodiment, the relative resistances to flow imparted by the variable orifice 116n associated with the respective inflatable chamber 110n and the corresponding actuator element branch line orifices 122n associated with the actuator branch lines 120n may be selected so that the resistance to flow through the variable orifice 116n is greater during the inflation phase than during the deflation phase or vice versa. Put another way, the relative resistances to flow imparted by the variable orifice 116n associated with the respective inflatable chamber 110n and the corresponding actuator element branch line orifices 122n associated with the actuator branch lines 120n may be selected so that the inflatable chamber 110n inflates faster than it deflates or vice versa.

More specifically, with reference to FIG. 11, first and second actuator branch line orifices 122A, 122B corresponding to first and second actuator elements 118A, 118B may be selected to impart substantially less resistance to flow than the variable orifice 116A corresponding to the first inflatable compartment 110A. In such embodiments, with the first selectively inflatable compartment 108 initially in a deflated state, introduction of pressurized fluid to the first selectively inflatable compartment 108 causes the first and second actuator elements 118A, 118B to fill and become pressurized more quickly than the first inflatable chamber 110A. As the first and second actuator elements 118A, 118B become inflated and pressurized, and before the first inflatable chamber 110A becomes inflated and pressurized, the first and second actuator elements 118A, 118B cooperate to impart a tensile force to the first and second sheets 104, 106 proximate the first variable orifice 116A and thereby place the first variable orifice 116A in the second state further to the principles discussed above. With the first variable orifice 116A in the second state, it imparts a relatively high restriction to flow therethrough into the first inflatable chamber 110A, so that the first inflatable chamber 110A fills and becomes pressurized relatively slowly. Similarly, with the first selectively inflatable compartment 108 initially in an inflated state, venting of pressurized fluid from the first selectively inflatable compartment 108 causes the first and second actuator elements 118A and 118B to vent and become depressurized more quickly than the first inflatable chamber 110A. As the first and second actuator elements 118A, 118B become depressurized, they cooperate to release the foregoing tensile force on the first and second sheets 104, 106 and thereby place the first variable orifice 116A in the first state further to the principles discussed above. With the first variable orifice 116A in the first state, it imparts a relatively low restriction to flow therethrough from the first inflatable chamber 110A, so that the first inflatable chamber 110A vents and becomes depressurized more quickly than it fills and becomes pressurized.

Conversely, the first and second actuator branch line orifices 122A, 122B corresponding to the actuator elements 118A and 118B may be selected to impart substantially greater resistance to flow than the variable orifice 116A corresponding to the first inflatable compartment 110A. In such embodiments, with the first selectively inflatable compartment 108 initially in a deflated state, introduction of pressurized fluid to the first selectively inflatable compartment 108 causes the first inflatable chamber 110A to fill and become pressurized more quickly than the first and second actuator elements 118A and 118B. As the first and second actuator elements 118A, 118B become pressurized, they cooperate to impart a tensile force to the first and second sheets 104, 106 and thereby place the first variable orifice 116A in the second state further to the principles discussed above. Prior to the first and second actuator elements 118A, 118B becoming pressurized, however, they impart a substantially lesser tensile force to the first and second sheets 104, 106 and thereby do not place the first variable orifice 116A in the second state further to the principles discussed above. With the first variable orifice 116A in the first state, it imparts a relatively low restriction to flow therethrough into the first inflatable chamber 110A, so that the first inflatable chamber 110A fills and pressurized relatively quickly. Similarly, with the first selectively inflatable compartment 108 initially in an inflated state, venting of pressurized fluid from the first selectively inflatable compartment 108 causes the first inflatable chamber 110A to vent and become depressurized more quicky than the first and second actuator elements 118A and 118B. Until the first and second actuator elements 118A, 118B become depressurized, they continue to impart the foregoing tensile force to the first and second sheets 104, 106 and thereby maintain the first variable orifice 116A in the second state. With the first variable orifice 116A in the first state, it imparts a relatively high restriction to flow therethrough from the first inflatable chamber 110A, so that the first inflatable chamber 110A vents and becomes depressurized more slowly than it fills and becomes pressurized.

FIG. 11 shows a first selectively inflatable compartment 108 having only one inflatable chamber 110A and one pair of corresponding actuator elements 118A. FIG. 12 shows a non-limiting variant of the FIG. 11 embodiment further including second through sixth inflatable chambers 110B-110F, second through sixth corresponding branch lines 114B-114F including respective second through sixth variable orifices 116B-116F, and corresponding pairs of actuator elements 118C/D, 118E/F, 118G/H, 118I/J, 118K/L including respective actuator branch lines 120n and actuator branch line orifices 122n. The foregoing variable orifices 116n and branch line orifices 122n may be selected as desired to enable substantially simultaneous or sequential inflation and pressurization of the inflatable compartments 110n, and to enable substantially simultaneous or sequential deflation and depressurization of the inflatable compartments 110n, further to the principles discussed above in connection with the FIG. 3-10 embodiments. The operation of the FIG. 12 embodiment should be readily understood in view of the descriptions of operation of the FIGS. 3-11 embodiments and thus will not be discussed further.

FIGS. 3-12 illustrate embodiments of the therapeutic device 100 wherein the actuator 118 comprises actuator elements 118n that cooperate in pairs to apply and release tensile forces to and from the first and second sheets 102, 104 comprising the therapeutic device 100 to thereby selectively change the respective cross-sectional area of one or more of the branch conduits 114n defining the variable orifices 116n thereof. The foregoing actuator elements 118n generally are coplanar with the branch conduits 114n defining the variable orifices 116n, and the tensile forces they effectively apply and release to the first and second sheets 102, 104 comprising the therapeutic device 100 generally act in the same plane as the actuator elements 118n and the corresponding branch conduits 114n defining the variable orifices 116n.

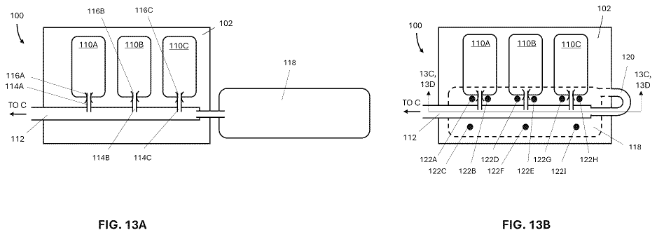

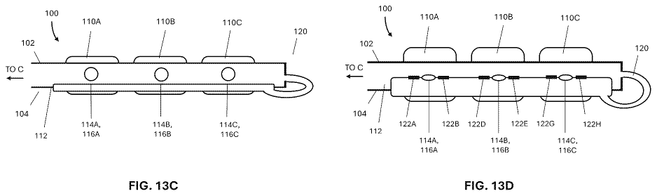

FIGS. 13A-13D show an embodiment of the therapeutic device 100 wherein the actuator 118 comprises an inflatable actuator element 118 configured to change the cross-sectional area of one or more of the variable orifices 116n by applying one or more corresponding compressive forces to the first and second sheets 102, 104 in one or more regions thereof defining the variable orifices 116n. The foregoing actuator element 118 generally is not coplanar with the branch conduits 114n defining the variable orifices 116n, and the compressive forces the actuator element applies and releases to the first and second sheets 102, 104 comprising the therapeutic device 100 generally act in a direction perpendicular to the plane comprising the actuator elements 118n and the corresponding branch conduits 114n defining the variable orifices 116n.

FIG. 13A shows the actuator 118 as an inflatable actuator element 118 distinct from the manifold 112 and fluidly connected to the manifold 112 by an actuator conduit 120. As shown, the actuator element 118 is defined by the first and second sheets 102, 104 defining the therapeutic device 100 as heretofore described. FIGS. 13B-13D show the actuator conduit 120 folded underneath the second sheet 104 of the therapeutic device and the portion of the second sheet 104 defining the actuator element 118 joined to the portion of the second sheet 104 defining the main portion of the therapeutic device 100 including, for example without limitation, the manifold 112, the inflatable chambers 110n, the branch lines 112n, and the variable orifices 116n by three sets of three spot welds 122n. Two of the spot welds 122n in each set of three spot welds 122n are disposed on a first side of the manifold 112 and on opposite sides of a corresponding one of the branch lines 114n defining a corresponding one of the variable orifices 116n. The third spot weld of each set of three spot welds 122n is located on a second side of the manifold 112 opposite the first side of the manifold 112, and generally opposite the two spot welds 122n flanking the foregoing branch line 114n.

More specifically, first and second spot welds 122A, 122B are located on a first side of the manifold 112, and on opposite sides of the first branch line 114A defining the first variable orifice 116A corresponding to the first inflatable chamber 110A. A third spot weld 122C is located on the opposite side of the manifold 112 generally opposite the first and second spot welds 122A, 122B, the first branch line 114A, and the first variable orifice 116A. Similarly, fourth and fifth spot welds 122D, 122E are located on the first side of the manifold 112, and on opposite sides of the second branch line 114B defining the second variable orifice 116B corresponding to the second inflatable chamber 110B. A sixth spot weld 122F is located on the opposite side of the manifold 112 generally opposite the fourth and fifth spot welds 122D, 122E, the second branch line 114B, and the second variable orifice 116B. Likewise, seventh and eighth spot welds 122G, 122H are located on the first side of the manifold 112, and on opposite sides of the third branch line 114B defining the third variable orifice 116C corresponding to the third inflatable chamber 110C. A ninth spot weld 122I is located on the opposite side of the manifold 112 generally opposite the seventh and eighth spot welds 122G, 122H, the third branch line 114C, and the third variable orifice 116C.

In embodiments, more or fewer spot welds 122n could be used to join the actuator element 118 to the main portion of the therapeutic device 100 as described above, and they could be located other than as described above. In embodiments, the actuator element 118 could be joined to the main portion of the therapeutic device 100 in other ways, including without limitation, elongated and/or broadened welds, adhesives, mechanical fasteners etc. In any event, the actuator element 118 is joined to the main portion of the therapeutic device 100 in a manner that enables the actuator 118 to impart a compressive force to the branch lines 114n when the actuator element 118 is inflated and to relieve the compressive force when the actuator element 118 is deflated so as the transition the variable orifices 116n between their respective first and second states.

FIG. 13C shows the actuator 118 in a deflated state wherein the actuator 118 does not impart a substantial compressive force on the branch lines 114n defining the variable orifices 116n so that the variable orifices 116n are in their respective first states in which the variable orifices 116n impart relatively little resistance to fluid flow. FIG. 13D shows the actuator 118 in an inflated state wherein the actuator 118 imparts a substantial compressive force on the branch lines 114n defining the variable orifices 116n so that the variable orifices 116n are in their respective second states in which the variable orifices 116n impart relative great resistance flow.

In use, the variable orifices 116n are initially in their respective first states. Pressurized fluid, for example without limitation, air, then is selectively provided to the manifold 112, for example without limitation, by the controller C. The resistance to flow through the manifold 112 and the actuator conduit 120 is substantially less than the resistance to flow through any of the variable orifices 116n, regardless of whether the variable orifices 116n are in the respective first or second states. As such, the introduction of the pressurized fluid pressure to the manifold 112 causes the fluid pressure in the manifold 112 and the actuator 118 to increase substantially faster than the fluid pressure in the inflatable chambers 110n. Thus, the introduction of the pressurized fluid to the manifold 112 substantially initially causes the actuator 118 to compress the branch lines 114n, thereby placing the variable orifices 116n in their respective second states, as discussed further above. Continued provision of the pressurized fluid to the manifold 112 then causes the ones of the inflatable chambers 110n to inflate and become pressurized substantially simultaneously or sequentially as a function of the relative resistances to flow of the variable orifices 116n in their second states.

The pressurized fluid may subsequently be vented from the manifold 112, for example without limitation, to the controller C. Because the resistance to flow through the manifold 112 and the actuator conduit 120 is substantially less than the resistance to flow through any of the variable orifices 116n, regardless of whether the variable orifices 116n are in the respective first or second states, the venting of the pressurized fluid pressure from the manifold 112 causes the fluid pressure in the manifold 112 and the actuator 118 therein to decrease substantially faster than the fluid pressure in the inflatable chambers 110n. As such, the venting of the pressurized fluid to the manifold 112 substantially releases the compressive force imparted to the branch lines 114n, and thereby allows the corresponding variable orifices 116n to adopt their respective first states. Continued venting of the pressurized fluid from the manifold 112 then causes the ones of the inflatable chambers 110n to deflate and become depressurized substantially simultaneously or sequentially as a function of the relative resistances to flow of the variable orifices 116n in their first states. In any event, in this embodiment, the inflatable chambers 110n would inflate and become pressurized more slowly than they would deflate and become depressurized.

In embodiments, the actuator conduit 120 could be configured to impart a greater resistance to flow than the variable orifices 116n. So configured, the operation of the FIGS. 13A-13D embodiment would be similar to the operation of the FIG. 11 embodiment. More specifically, the introduction of the pressurized fluid pressure to the manifold 112 would cause the fluid pressure in the inflatable chambers 110n to increase substantially faster than the fluid pressure in the actuator 118. Thus, the introduction of the pressurized fluid to the manifold 112 would cause the inflatable chambers 110n to become inflated and pressurized before the actuator 118 became pressurized, thereby placing the variable orifices 116n in their respective second states. Prior to the actuator 118 becoming pressurized, the variable orifices 116n would be in their respective first states. Upon deflation, the inflatable compartments 110n would deflate and become depressurized more quickly than the actuator 118. The variable orifices 116n would remain in their respective second states until the actuator 118 deflated and became depressurized. Thus, in this embodiment, the inflatable chambers 110n could be inflated and pressurized more quickly than they could be deflated and depressurized.

The embodiments shown and described herein are illustrative and not limiting. Those skilled in the art would understand how to modify the illustrative embodiments without departure from the scope of the appended claims.

1. A therapeutic surface comprising:
a first flexible sheet and a second flexible sheet overlying and joined to the first flexible sheet to thereby define a first selectively inflatable compartment comprising:
a first manifold, the first manifold configured for fluid coupling to a controller configured to selectively supply pressurized fluid to and vent the pressurized fluid from the first manifold;
a first inflatable chamber;
a first branch line fluidly coupling the first inflatable chamber to the first manifold, the first branch line comprising a first variable flow restrictor operable between a first state wherein the first variable flow restrictor has a first, relatively low resistance to flow at a reference differential pressure across the first variable flow restrictor orifice, and a second state wherein the first variable flow restrictor has a first relatively high resistance to flow at the reference differential pressure across the first variable flow restrictor;
a second inflatable chamber;
a second branch line fluidly coupling the second inflatable chamber to the first manifold, the second branch line comprising a second variable flow restrictor operable between a first state wherein the second variable flow restrictor has a second relatively low resistance to flow at the reference differential pressure across the second variable flow restrictor, and a second state wherein the second variable flow restrictor has a second relatively high resistance to flow at the reference differential pressure across the second flow restrictor orifice; and
an actuator operable to transition the first variable flow restrictor between the first and second state and to transition the second variable flow restrictor between the first state and the second state.

2. The therapeutic device of claim 1, wherein the first variable flow restrictor comprises a first variable orifice, and the second variable flow restrictor comprises a second variable orifice.

3. The therapeutic device of claim 2, wherein the actuator comprises a first actuator element on a first side of the first branch line and a second actuator element on a second side of the first branch line opposite the first side of the first branch line, wherein the first actuator element and the second actuator element are integral with the first manifold.

4. The therapeutic device of claim 3, wherein the first actuator element and the second actuator element cooperate to apply a tensile force on the first sheet and the second sheet between the first actuator element and the second actuator element in response to inflation of the manifold.

5. The therapeutic device of claim 4, wherein application of the tensile force causes the first variable orifice to adopt the second state and wherein absence of the tensile force enables the first variable orifice to adopt the first state.
